(19) United States
(12) Patent Application Publication
(10) Pub. No.: US 2004/0196607 A1
(43) Pub. Date: Oct. 7, 2004

(54) Electrical protection device and method for manufacturing said device

(76) Inventor: Clair Didier, Regensburg (DE)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/794,250

(22) Filed: Mar. 5, 2004

(30) Foreign Application Priority Data
Mar. 7, 2003 (DE) 10310122.5

(51) Int. Cl. H02H 5/04

(52) U.S. Cl. 361/104

(57) ABSTRACT

An electrical protection device is provided which combines the functions of an external connecting element and a safety fuse with a circuit-side contactable connecting element in a very small and compact component

### PRIORITY

This application claims foreign priority to German application number DE10310122.5 filed Mar. 7, 2003.

### TECHNICAL FIELD

The present invention relates to an electrical protection device.

### BACKGROUND OF THE INVENTION

Electrical protection devices, in particular in the form of safety (melting) fuses, have been known for a long time. They are differentiated in the known manner according to rated current range, threshold voltage range, fast-acting or time-delay tripping characteristic or design and mounting shape as well as intended use, to name just a few distinguishing criteria. A common feature of all the designs of electrical protection devices cited by way of example in the foregoing is that even in the form of chip fuses or microfuses for power supply and control functions it is becoming increasingly difficult to integrate them into circuits because of an installation space that is in each case subject to heavy demands.

A particularly critical situation arises within a motor vehicle electronics system or motor vehicle controller unit. In this situation, extreme demands are made on the safety of vehicle passengers and drivers. The scope of power functions to be electrically protected and therefore, also the number of vehicle controller units will continue to grow strongly overall in the near future in particular in passenger vehicles. However, the space for units of this kind is severely limited. Consequently the integration of electrical protection measures into controller units already causes great problems today with regard to a respective placement and a respective space requirement. Owing to an increasing integration density of the elements inside a controller unit, even today electrical protection devices can only be integrated with increasing difficulty.

As is known, miniature safety fuses are used as fuse types with very small space requirements. These include for example so-called blade fuses in the form of so-called mini-fuses, or protection circuits with a polymer fuse body, so-called poly switches.

### SUMMARY OF THE INVENTION

The object of the present invention is to create an electrical protection device with space requirements reduced beyond the known extent, and to provide a corresponding manufacturing method.

This object is achieved, according to the invention, by a device with the following features: two connecting elements wherein a first connecting element is embodied as an external connecting element of the electrical protection device and a second connecting element is embodied as a means of making electrical contact of the electrical protection device with a conductor, a conductor track, a board and/or in or on some other circuit carrier of an electrical circuit. An electrical protection device according to the invention thus, implements two functions simultaneously, namely the creation of an external connecting element for connecting or making electrical contact with a following electronic circuit as well as a fusing function in addition.

An electrical protection device according to the present invention preferably comprises at least one fusing conductor. In a preferred application, the protection of motor vehicle electronics and/or controller circuits, an electrical isolation of a following electrical circuit is effected in this way in a fault situation by the external connecting element at voltage levels of 12 up to approx. 48 volts and currents up to about 100 amperes. Series and/or parallel connections of a plurality of fusing conductors can be used as the actual protecting element. Alternatively, mechanical reversible disconnecting means or polymer fuse bodies can also be used as an electrical protection device instead of or in addition to the fusing conductor.

The external connecting element can be implemented in embodiments of the invention as a socket, but also as a pin, plug connector or else some other contacting or connection means. The second connecting element is advantageously embodied essentially in pin form for making electrical contact with a printed circuit board (Printed Card Board or PCB for short) by soldering or according to a pressfit contacting method. As an alternative to this, the second connection is advantageously embodied for a surface-oriented insertion and electrical contacting according to an SMD method.

In a preferred embodiment of the invention the external connection, the protection device and the second connecting element are implemented in one piece. They are preferably produced as stamped and bent parts from a wire or a metal sheet. All materials and/or material combinations known according to the prior art in the field of safety fuse manufacture can be used.

In an advantageous embodiment of the invention the external connecting element is installed in a housing which essentially encloses a relevant circuit carrier. In this way the electrical protection device is protected against mechanical overload, but also against the effect of an ambient atmosphere containing humidity and/or contaminants, etc. This applies in particular to an area of a fusing conductor. Advantageously, however, the electrical protection device is enclosed by a separate housing to the extent that the external connecting element and the second connecting element are exposed only in a way and to a degree provided to allow sufficient electrical contact to be made in each case. Thus, both connecting elements are installed in a common housing and at the same time a fusing conductor can also be enclosed. Plastics in the form of latching clips are suitable for a housing of this kind, as also are, e.g., plastic moldings. Ceramic housings can also be used for this purpose.

A cavity can advantageously be provided in a housing of this kind in an area around the fusing conductor. A cavity of this kind can then be used in a way known to a person skilled in the art for influencing a tripping characteristic and/or a cutoff response of the fusing conductor, for example by means of a coating and/or filling with a porous and temperature-resistant material. The use of, for example, quartz sand or special substances which quench a switch arc is known from the field of tube fuse elements.

The housing can be embodied as an insulating guide, in particular in the area of the external connecting element, or also as the counterpart of an external connecting plug. An electrical protection device according to the invention can advantageously be disposed together with a second external connection in a common housing, in particular as a reverse polarity protected arrangement for supplying electrical power to a post-connected electrical circuit.

### BRIEF DESCRIPTION OF THE DRAWINGS

Further embodiments and advantages of device according to the invention will be described in more detail in the following with reference to exemplary embodiments and with the aid of the drawing, in which:

FIG. 1: shows a first embodiment of an electrical protection device in a side view,

FIG. 2: shows a schematic side view of a second embodiment in an in situ situation, and

FIG. 3: shows a third embodiment of a protection device in an in situ situation similar to the in situ position shown in FIG. 2.

### DETAILED DESCRIPTION OF THE PREFERRED EMBODIMENTS OF THE INVENTION

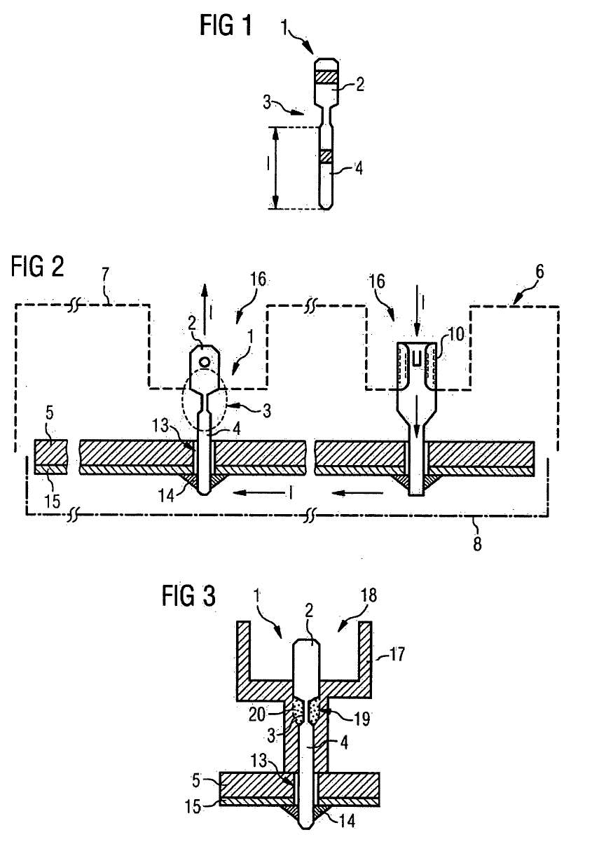

An electrical protection device 1 comprises an external connecting element 2 which is connected via a fusing conductor 3 to a second connecting element 4. In the embodiment shown in FIG. 1, the external connecting element 2 is implemented as a contact plate or reed with a rectangular cross-section, whereas the second connecting element 4 is implemented as a pin with an essentially square cross-section. The external connecting element thus forms a mating contact element such as is frequently used particularly in the automotive sector as a male plug connector part together with crimpable plug-in contact elements as female counterparts.

The second connecting element 4 essentially corresponds in its dimensions and its cross-sectional shape to those of known contact pins. Contact pins of this kind are inserted according to the prior art by pressing in according to a press-fit contacting method or else by soldering in a circuit carrier 5 in the form of a printed circuit board, as illustrated in FIG. 2 and described in the following.

In the sectional representation shown in FIG. 2, the electrical protection device 1 from FIG. 1 is shown in an in situ position. An electrical circuit (not shown) is disposed on the printed circuit board 5 and enclosed by a housing 6 with a housing upper part 7 and a housing lower part 8. Electrical power to drive the circuit is provided via an external connection 10 and the external connecting element 2 of the electrical protection device 1. A resulting exemplary current path I via the external connections 2, 10 is drawn using the arrows. In the event of a malfunction due to an overvoltage or too high a current I, the circuit and also any following circuits are protected against malfunction and/or destruction in that the current path is split in the area of the fusing conductor 3.

Following a fault situation of this kind, the illustrated circuit together with the housing 6 is replaced. Separating the electrical connections is very easily possible in this case, since the external connection 10 is embodied as a plug-in contact element and the external connecting element 2 of the electrical protection device 1 is embodied as a corresponding mating contact element. Pairs of plug-in contact elements of this type in male and spring elastic female form are widespread most especially in the field of automotive engineering.

A length l of the second connecting element 4 is chosen here such that the electrical protection device 1 can also be picked and/or held at the second connecting element 4 by an automatic placement machine for computer-controlled loading of a printed circuit board 5. This means that in addition to a press-fit means of establishing electrical contact electrical and mechanical connections based on wave, reflow or laser soldering methods can also be used.

The protection device 1 in the exemplary embodiment shown in FIG. 2 experiences a mechanical fixing of its position by the mounting of the second connecting element 4 in a cutout 13 of the board 5 with subsequent contacting by means of tin-base solder 14 with a respective copper conductor track 15. The thickness of a respective copper conductor track of the printed circuit board (PCB) 5 can range from approx. 18 to approx. 800 μm.

In the embodiment shown in FIG. 2, however, a significant contribution to the mechanical fixing of the protection device 1 is made by the external housing 6, in which the protection device 1 is mechanically fixed essentially by the external connecting element 2 being pressed in the housing upper part 7. In this way the fusing conductor 3 is also protected against harmful external environmental influences by the housing upper part 7. As well as providing protection against contaminant accumulation and humidity, however, the housing upper part 7 also offers the fusing conductor 3 mechanical protection by acting as a kind of pull and pressure relief means.

In the exemplary embodiment shown in FIG. 2, the two external connecting elements 2, 10 of the electrical circuit (not shown in further detail) are mechanically fixed in the housing upper part 7 of the external housing 6. The arrangement of the two external connecting elements 2, 10 on the circuit and their arrangement relative to the external housing 6 is of no further relevance in this instance. The arrangement can be flexibly adapted to the particular requirements, as the form of representation of only one section chosen in the illustration in FIG. 2 is intended to indicate. In the present case, sketched recesses 16 in the housing upper part 7 produce a lowering of the external connecting elements 2, 10 relative to an external edge of the housing 6. This measure is useful as a protection for the connecting elements 2, 10, but is not absolutely essential.

As an alternative to the kind of mechanical fixing and protection in particular of the fusing conductor element 3 just described with reference to the illustration in FIG. 2, in FIG. 3 the electrical protection device 1 is enclosed by a separate housing 17. The areas of the external connecting element 2 and the second connecting element 4 required in each case for establishing an electrical contact are exposed by the housing 17 in a manner shown in FIG. 3. Whereas the electrical contact between the second connecting element 4 and a conductor track 15 of the board 5 is made in the manner already described, one external connection 2 is embodied in the form of a pin. To provide mechanical protection and also to act as a guide for a female plug-in contact connector element (not shown), the external connection 2 is enclosed in an essentially funnel-shaped cavity 18 of the housing 17. As the housing 17 in fact exposes the external connection 2 in the area of the funnel-shaped cavity 18, but projects above it in height, it essentially also takes over the protective function of a recess 16 in a housing upper part 7 as described in relation to FIG. 2. Moreover, integration of the described component in a housing 6, for example in the form of an insert, is not excluded. In this way the design of a housing upper part 7 can advantageously be simplified and the manufacturing costs in terms of a deep-drawing or injection molding tool lowered.

A housing 17 of the type shown in FIG. 3 offers even more possibilities for functional embodiment beyond a protective function for a fusing conductor 3. For example, the housing 17 can have a cavity 19 in the area of the fusing conductor 3, as indicated in FIG. 3. When the fusing conductor is tripped or switched off, this cavity 19 can accommodate an arc or plasma. By this means the pressure load on the housing 17 can be greatly reduced and consequently an escape of metal vapors from the housing 17 avoided when the fusing conductor 3 is switched off.

In the present case the cavity 19 has been implemented very simply in that the housing 17 is embodied in the form of two latching clips made of a plastic. In a half shell of this type a half space can be implemented very easily and manufactured cheaply as a pressure-cast or injection molded part. Alternatively, two half-housings made of other electrically non-conducting and temperature-resistant materials can also be simply bonded together, for example two half-housings made of a ceramic material.

By means of a cavity 19 of the type described a respective tripping characteristic can be very considerably influenced by interventions drawing on a heat budget of the fusing conductor 3. Thermal isolation will tend to cause more of a fast-acting tripping characteristic. On the other hand, close contact of the fusing conductor 3 with a filling compound supports more of a slow-acting tripping characteristic due to the heat dissipation and cooling associated with the contact. Direct contact with the material of the housing 17 can produce a similar effect.

Furthermore, in the present case a switch-off behavior of the electrical protection device 1 is influenced by use of a special arc-quenching sheath 20 of the fusing conductor 3 or alternatively a filling in the cavity 19. However, these measures are known according to the prior art to a person skilled in the art to such an extent that the description will not go into further details at this juncture.

In an embodiment of the invention also not illustrated graphically in further detail here, the second connecting element 4 is embodied for insertion on a board 5 according to an SMD process. Embodiments of connecting elements of this kind are known to the person skilled in the art from the field of surface-mountable discrete resistors, capacitors, integrated circuits, jumper and terminal strips, etc. with numerous embodiments from the prior art. By means of a flattening and/or vertical angling of a suitably dimensioned end area of the second connecting element 4, this measure can also be implemented in one production step of a stamping-bending process based on a metal sheet and also based on a metal wire in the known fashion.

Thus, an electrical protection device 1 in a plurality of embodiments and variations has been described in the foregoing, said device combining the functions of an external connecting element 2 and a safety fuse with a circuitside contactable connecting element 4 in a very small and compact component. All manufacturing methods known from the prior art for producing safety fuse elements can be used without restriction for a device of this type. In the exemplary embodiments shown in FIGS. 1 to 3, the external connecting element 2 with the fusing conductor 3 and the second connecting element 4 are manufactured together as a stamped and bent part out of a surface silver-coated copper sheet. Electrotinned copper sheets can, of course, also be used. Furthermore, subsequent treatment and/or coating of the fusing conductor 3 is also possible.

In a further embodiment of the invention (not shown graphically), the external connecting element 2 and the second connecting element 4 are designed as pin contacts of essentially the same cross-section, so that in this case the fusing conductor 3 can be advantageously punched and/or etched out from a wire.

A protection device 1 according to the invention is also contactable using all insertion methods known for discrete components. Moreover, in terms of its design principle the protection device 1 is implemented as an automation-friendly component and can be very efficiently used directly in press-fit, plug-in solder or SMD insertion and contacting methods.

There consequently result as advantages that an installation space required for implementing the protective function of a safety fuse is very greatly reduced through the use of a protection device 1 according to the invention. By means of a protection device 1 according to the invention in particular less of the already tightly dimensioned space available on a respective circuit carrier is required. Essentially, the space requirement of a protection device 1 according to the invention is advantageously restricted to that of an external connecting element 2, which has to be provided in any case on a circuit.

Finally there is also no need to provide a female connection for the fuse element on the circuit side. As a result at least one component and one process step is saved in the manufacture.

In the foregoing description, use of the device in the automotive field for protecting various controller and electronics elements was emphasized in order to illustrate the advantages and various embodiments of the present invention. However, this is expressly not to be seen as any restriction of the use and adaptation of a protection device 1 according to the invention to this field. The described advantages of a device according to the invention can also be realized in the same way when it is used in other fields of low-voltage electronics and energy supply at a midrange power level.

What is claimed:

1. An electrical protection device comprising first and second connecting elements, wherein the first element provides an external connection point for the device, and the second element provides a contact point for the device to an electrical circuit in or on a circuit carrier.

2. A device according to claim 1, wherein the electrical protection device comprises at least one fusing conductor.

3. A device according to claim 1, wherein the first connecting element comprises a socket, pin, plug connector, or some other contacting or connection means.

4. A device according to claim 1, wherein the second connecting element comprises a pin for making electrical contact with a printed circuit board via soldering or according to a press-fit contacting method.

5. A device according to claim 1, wherein the second connecting element is adapted to make electrical contact according to an SMD method.

6. A device according to claim 1, wherein the first connecting element, the protection device, and the second connecting element are implemented in one piece.

7. A device according to claim 1, wherein the first connecting element, the protection device and the second connecting element are implemented together as stamped and bent parts made from a wire or a metal sheet.

8. A device according to claim 1, wherein the first connecting element is installed in a housing.

9. A device according to claim 1, wherein the electrical protection device is substantially enclosed by a separate housing so that the first and second connecting elements are only exposed to allow sufficient electrical contact with each element.

10. A device according to claim 9, wherein the separate housing is in the form of a insulating guide.

11. A device according to claim 9, further comprising a third connecting element together in the separate housing, said third connecting element being in a reverse polarity protected arrangement for supplying electrical power to a post-connected electrical circuit.

12. A method for manufacturing an electrical protection device, said method comprising manufacturing a first external connecting element with a fusing conductor, and a second connecting element for making electrical contact with a conductor, a conductor track, a board and/or some other circuit carrier of an electrical circuit together from a stamped or stamped and bent part of a metal sheet or metal wire.

13. A method according to claim 12, wherein the electrical protection device is surrounded by a separate housing by plastic molding or by bonding together two half-housings made of plastic or ceramic material leaving exposed at least the areas of the connecting elements.

14. A method according to claim 12, wherein the electrical protection device is configured for insertion in a circuit in an automation-friendly manner according to a press-fit, plug-in solder or SMD insertion and contacting method.
